(19) United States
(12) Patent Application Publication
(10) Pub. No.: US 2023/0006508 A1
(43) Pub. Date: Jan. 5, 2023

(54) Permanent Magnet Engine

(71) Applicant: Shamila Panneer Selvam, (US)

(72) Inventor: Shamila Panneer Selvam, (US)

(21) Appl. No.: 17/367,305

(22) Filed: Jul. 2, 2021

(51) Int. Cl. H02K 7/10; H02K 5/04; H02K 7/02

(52) U.S. Cl. CPC H02K 7/1004; H02K 5/04; H02K 7/02

(57) ABSTRACT

Converting magnet repulsion/attraction force into continuous mechanical energy by simulating the meeting distance of two different magnet using a magnetic shield material. Design uses structure made up of non-magnetic material, inside the structure there is a piston made up of permanent magnet that moves up and down. Another permanent magnet is fitted on top of the structure, facing with same magnetic pole. In between the fixed magnet and moving magnet a layer is made up of magnetic shield material is used to block the magnet fields' passes between the magnets. The shield layer will open when the moving magnet about to move down using the crankshaft and very near to the fixed magnet, so that both magnets will repel each other and push the moving magnet away. When the moving magnet reaches the crankshaft repositioning position then the magnet shield layer on the top will close to block the magnetic fields, by doing this the moving magnet connected to the piston or connecting rod will moves up without facing any repulsive force and the cycle continues to produce continuous energy.

### FIELD OF INVENTION

Engine that produce mechanical energy using a permanent magnet as an input source. Using the magnet repulsion and attraction force mechanical energy is retrieved. Magnet shield is used to achieve continuous mechanical energy by controlling the meeting point of two magnets.

### BACKGROUND OF INVENTION

Energy is the core fundamental demand for individuals and countries. To generate energy there should be some input required in form for Coal, Water, Wind, Nuclear and other means. However, those are expensive for certain countries or a single family to generate energy to live a self-sufficient life. To solve the problem my invention has come out using Permanent Magnet as an input source and through custom design continuous mechanical energy will be generated. From that mechanical energy other forms of energy can be retrieved like generating electricity power or driving automobiles or operating household appliances and any automated products. Since the input source for this engine is a permanent magnet depending on fossil fuels can be totally avoided and generate power through clean energy.

### SUMMARY OF THE INVENTION

Based on my research and experiment, continuous energy from permanent magnets cannot be retrieved by gradually/linearly positioning of two permanent magnets facing each other with the same pole. To solve the problem, in this design a Permanent magnet shield is used to generate spontaneous repulsive or attraction force from the magnet. Spontaneous force from magnets can be generated from the magnets by making two magnets meet each other facing the same pole in a very short distance and at a very short interval.

In most of the permanent magnet based energy generation concept/experiments, permanent magnets are used to position against another permanent magnet to achieve repulsive or attraction using flywheel or other means. In all the existing approaches the distance between the two magnets are separated by graduaVlinearly. In gradual/linearly separation designs the repulsive or attraction force between the magnets or external force like Flywheel will gradually bring the system to a stable position after few movement. The reason is according to magnets it will start repulsion or attractions as soon as it meets from far distance. So gradually either the magnet force or flywheel force will win and brings the system to stable and will not allow the cycle to be continuous. To overcome the problem, I have used magnetic shield to block the magnet force that brings the system stable and unblocks the magnetic force only while generating a force. So that continuous energy can be retrieved. The key point of this design/invention is; both two magnets will not know how far they are separated from each other until the magnetic shield opens. The key advantage of this product is it provides an ability to fit in any existing engine structure type for example: Parallel, Twin, V-Twin, flat twin or radial type design.

### BRIEF DESCRIPTION OF THE DRAWINGS

FIG. 1 is a schematic view of engine, where the magnet in the middle that is attached to the connecting rod is pushed down by the repulsive force of the top permanent magnet as well as it pulled down by the magnet that is located in the bottom of the engine.

In FIG. 1 While the middle magnet moves down; it will hit the lever on it path and pull it down along with it. The lever is connected to the magnetic shield block with a mechanism to closed the path of all magnets. The reason for closing the magnets path are due to flywheel effect the middle magnet moves up freely without any repulsive or attraction force.

FIG. 2 is a schematic view of engine, where the middle magnet moved up by the flywheel force and hits the magnetic shield lock, as soon as the lock is released the magnetic shield moves away from the path of magnets and allow the magnetic fields of all magnets to meet each other to gain spontaneous repulsive and attraction.

FIG. 3 is a schematic view of engine where external source (motor, sensor and microcontroller) is used to operate the magnetic shield block opening and closing. This is to block and unblock the magnetic fields. In FIG. 3 the moving magnet reaches the sensor on the top and ready to move down due to crankshaft rotation, at that time the controller will send signal to motor to open the magnetic shield doors, so that both magnets will repulsive each other and generate force on crankshaft to rotate.

FIG. 4 is a schematic view of engine where the moving magnet reaches the sensor located on the bottom of the engine and crankshaft about to push the magnet up. The controller send signal to motor to close the magnetic shield doors, so that the moving magnet can move up freely without any repulsive force.

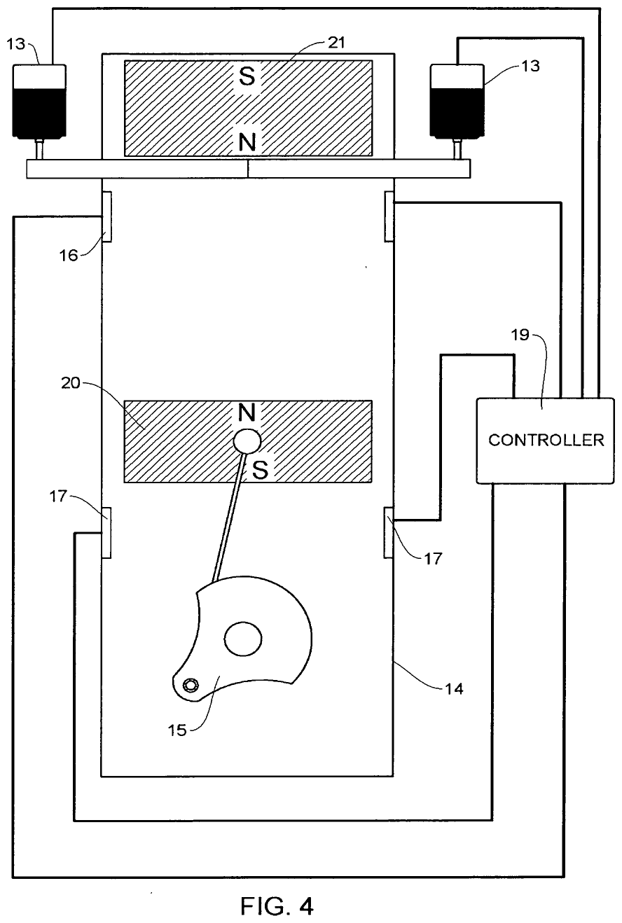

FIG. 5 is a schematic view of engine where the mechanical power that are required to open and close the magnetic shield is drawn from the engine operation power by having a lever on the path of moving magnet and the lever is connected to the magnetic shield to achieve close operation and spring is use to achieve shield open operations.

FIG. 6 is a schematic view of engine where the moving magnet hit the lock holding the magnetic shield and releases the magnetic shield from the path of both magnets. Spring that is connected to the magnetic shield will pull out from the path of magnets while the crankshaft about to pull the moving magnet down.

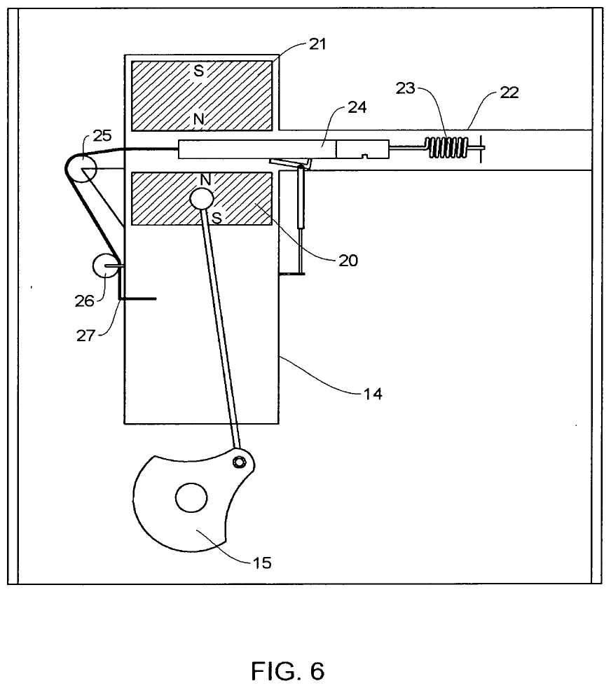

FIG. 7 is a schematic view of engine, where the magnetic shield is fully opened and both the magnet meet each other by facing each other with its same pole, due to magnet repulsion nature, the fixed magnet on the top will pushes the moving magnet away, that rotates the crankshaft connected with it. While the moving magnet goes down on its path it hits the lever and pulls along with it, while the lever is connected to the magnetic shield and get pulled by the lever and it closes the path of the magnets.

### DETAILED DESCRIPTION

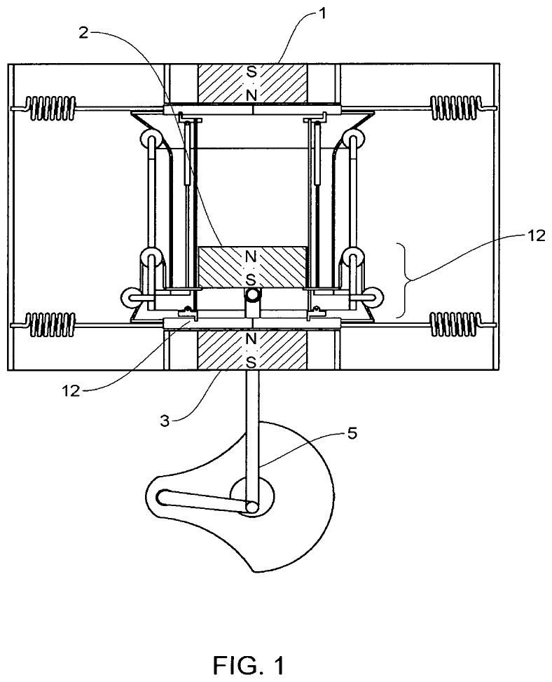

This invention is engine that converts the magnetic force into mechanical energy by simulating the meeting point of both the magnet through custom design. The input for this engine is Permanent magnets. The engine structure is made up of non-magnet reactive material, inside the engine there are three Permanent magnets are used to generate efficient energy (Two magnets can also be used to handles less loads. First magnet is placed on the top of the structure facing its north pole toward the bottom of the engine structure, as mentioned in FIG. 1 (no: 1). The second magnet is placed in the bottom of the structure facing its North Pole facing toward the upper portion of the engine, as mentioned in FIG. 1 (no: 3). The third magnet is placed between the top and bottom magnet with it north pole facing toward the top and the South Pole face the bottom of the cylinder, as mentioned in FIG. 1 (no: 2).

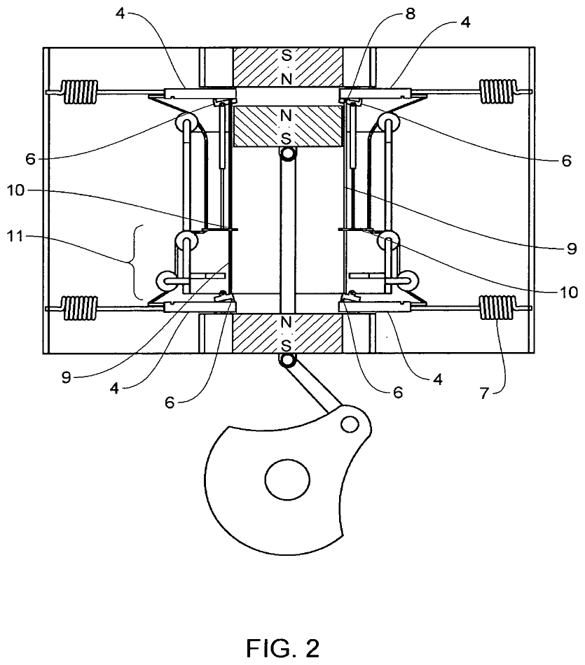

The engine is designed to allow the third magnet FIG. 1 (no: 2) to move up and down inside the structure as presented in the diagram FIG. 1. A power transmission rod is connected to the moving magnet. The other end of the rod is connected to the crankshaft as shown in the diagram FIG. 1 (no: 5). In the design the purpose of the crankshaft is repositioning the moving magnet using the reciprocate action either through flywheel or other loads. A door FIG. 2 (no: 4) is made up of material that can block the magnet fields of moving magnet reaching the top and bottom fixed magnets. To open and close the magnet shied door a lock FIG. 2 (no: 6) is designed to hold the door and releases to open the path as shown in the diagram. To open the Magnetic shield doors a spring FIG. 2 (no: 7) is used to pull each half of the door away from each other and opens the path of all magnets and allow the magnetic fields to reach the other magnets as shown in the diagram FIG. 2. The lock is placed in the position with a mechanism where the moving magnet can push and release the lock when it hits on its path, as shown in the diagram FIG. 2 (no: 8). A push rod is used to connect the bottom lock and top lock, the purpose of the push rod is to release both locks at same time as shown in the diagram FIG. 2 (no:9). To close the magnetic shield door, a custom mechanical design is set up in such a way that the moving magnet when it moves toward the bottom of the engine it will hit a knob on its path and pull along with it path as shown in the diagram FIG. 2 (no:10). The knob is connected to the upper and lower magnetic shield door in such a way that if the knob is pushed down it will also pull the shield door towards each other and blocks the magnetic fields magnets reaching each other as presented in the diagram FIG. 2 (no:11). The knob will pull the shield doors towards each other until the door get lock; as shown in the diagram FIG. 1 (no:12).

### Working Details

To start the engine, the flywheel is rotated to move the piston (middle magnet) to the top of the engine. When the piston hits the magnetic shield lock, the lock opens the magnetic shield doors that blocking the magnetic fields of top and bottom magnet. This action will allows the magnetic fields of fixed magnets to reach the moving magnet. Since the moving and top magnet are-setup to meet each other facing with the same pole and the bottom magnet facing opposite pole, the top magnet will push the moving magnet away and the bottom magnet will pull the moving magnet towards it. Using this approach; force is generated effectively using the attraction and repulsion characteristics of the magnets. This particular process produces force to move the connected rod and rotate the crankshaft and generate mechanical energy. While the moving magnet moves towards the bottom part of the engine, before it gets attracted by the magnet in the bottom of the engine or reaches the bottom magnet; the shield doors will close by piston through pulling the lever FIG. 2 (no:10) and blocks the magnetic fields between the moving magnet and bottom & top magnet. Due to the flywheel effect the moving magnet reciprocates and moves toward the top magnet freely without any repulsive and attraction force and hits the lock and releases the door FIG. 2 (no:4), the cycle continues until the shield doors are forcefully closed and cut off the magnetic field path between the magnets.

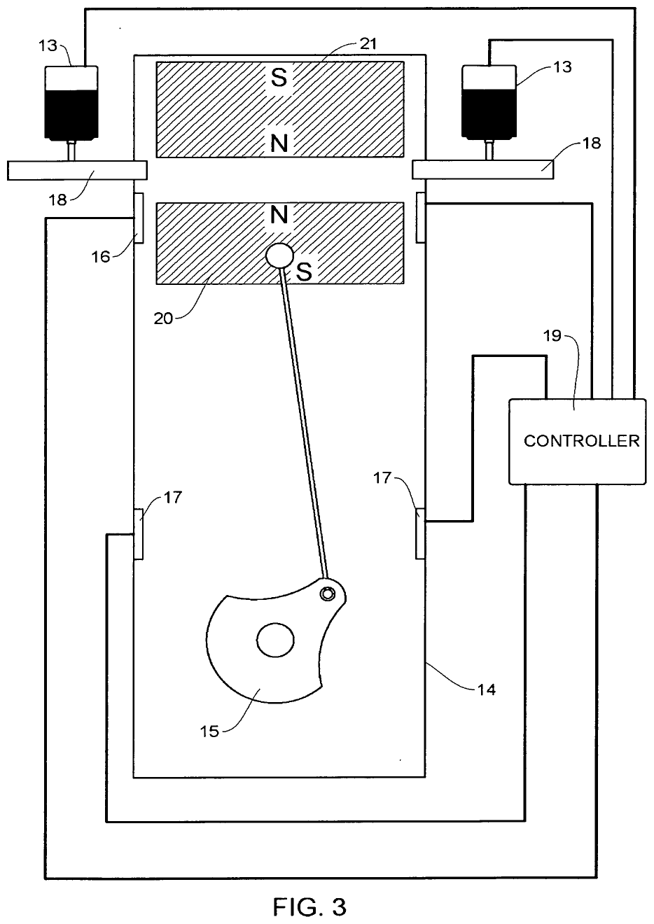

Design 2: Approach using external power to control the magnetic shield doors. (FIGS. 3 & 4)

In this design a low voltage external motor FIG. 3 (no: 13) is used to reciprocate the open and close operation of the magnetic shield doors FIG. 3 (no: 18). A position sensor FIG. 3 (no: 16 & 17) is used to identify the position of the moving magnet that is attached to the piston. A Micro controller FIG. 3 (no: 19) is used to receive the input from the sensor and send signal to the motor to open or close the magnetic shield door. The micro controller is configured to close the magnetic shield door when it receive input from bottom sensor FIG. 3 (no: 17) and open the shield door when it receives the signal from the top sensor FIG. 3 (no: 16). The opening and closing speed of the door is configured in controller based on the crankshaft stroke height and power of magnets. The purpose of this configuration is when then moving magnet FIG. 3 (no: 20) reaches the top sensor FIG. 3 (no: 16) then the microcontroller will open the magnetic shield door, then both the magnets will meet each other at short distance and due to repulsive force the moving magnet that is attaches to the piston will move down and rotates the crankshaft and the reaches the bottom sensor. As soon as it reaches the bottom sensor then the microcontroller will send signal to the motor to close the shield doors FIG. 3 (no: 18), so that the crankshaft can push the moving magnet to top without any repulsive force of the top fixed magnet FIG. 3 (no: 21). This cycle continues and generate mechanical energy from the magnetic force.

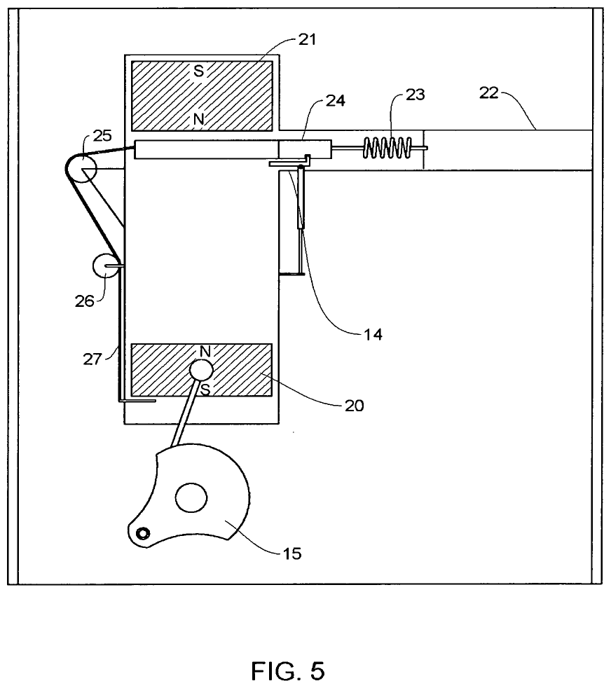

Design 3: Approach using two magnet without external power supply FIG. 5,6,&7).

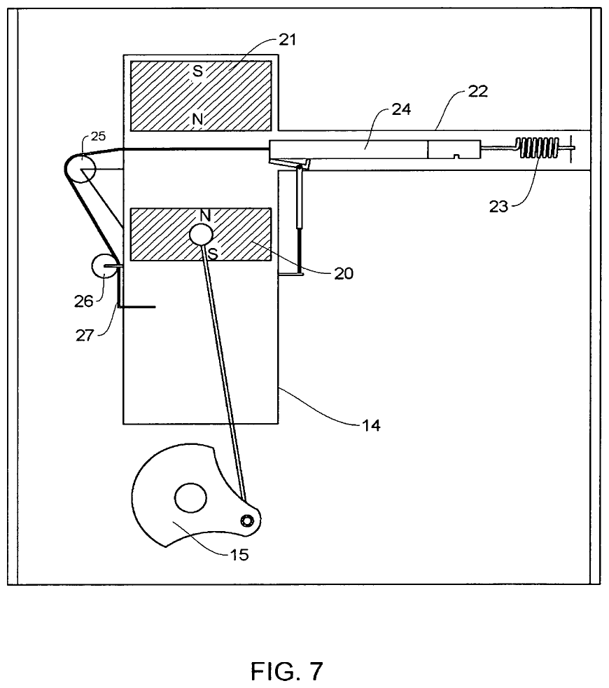

In this design and approach to retrieve mechanical energy without using external power to block and unblock the magnetic shield a custom design is used to control the magnetic shield open and close using the force generated by the magnets. Refer the FIG. 5. In this design a magnetic shield door is connected to the spring to keep it in open position like mentioned in FIG. 7 (no: 24). A lever FIG. 7 (no: 27) is setup in the path of the moving piston FIG. 7 (no: 20) made up of permanent magnet. When the piston goes down it will also pull the lever on its path. The lever is connect to the magnetic shield door through pulley setup as shown in the FIG. 7 (no: 25 & 26). The lever is placed in the position where it can go down until the connected magnet shield doors FIG. 7 (no: 24) is pulled and closes the path of both magnets as shown in FIG. 5 (no: 24) and get locked in the door lock as shown in the FIG. 5 (no: 24), also where the crank shaft starts to reposition the piston moves up. The crankshaft is connected to the flywheel and the flywheel will move the piston to the top by releasing the energy from the flywheel. Since the shield doors blocks the magnets fields so the moving magnet moves up without any repulsive force, and hit the door lock and release it. As soon as the lock is released then the magnetic shield door will open immediately and both magnet will meet at very short distance at its same pole facing each other, so the spontaneous repulsive force is generated and push the moving magnet down and the cycle continuous and produce mechanical energy until the magnetic shield door is not forcefully locked.

1. An engine comprising:
a plurality of permanent magnets to extract a repulsion and attraction force, wherein two of the plurality of permanent magnets are a fixed permanent magnet, and one of the plurality of magnets is a moving permanent magnet;
a piston is configured to move up and down inside the engine;
a door to block and unblock magnetic fields of the plurality of permanent magnets;
a crankshaft to convert linear motion into rotational motion;
a lock to hold the door in a closed position to block the magnetic fields of the plurality of permanent magnets;
a spring to pull the door away to unblock path of the magnetic fields of the plurality of permanent magnets;
a lever is configured in such a way that the lever gets pulled by the moving permanent magnet on its path, wherein the lever is connected to the magnetic field blocking and unblocking door, wherein when the lever goes down, the door gets pulled and close the path of the fixed permanent magnets; and
a flywheel is configured to gain energy from the repulsion or attraction force of the plurality of permanent magnets, wherein the flywheel releases the energy to reposition the moving permanent magnet to an inner top of the engine to open the door by hitting the lock.

2. The engine as claimed in claim 1, wherein one fixed permanent magnet is located at the inner top of the engine, and another fixed permanent magnet is located at an inner bottom of the engine, facing same pole to each other.

3. The engine as claimed in claim 1, wherein the moving permanent magnet is attached to the piston.

4. The engine as claimed in claim 1, wherein a non-magnetic material is used to design and manufacture an engine structure, wherein the engine structure does not react with the fixed permanent magnets and the moving permanent magnet.

5. The engine as claimed in claim 1, wherein the door is made up of a magnetic shield material to block the magnetic fields between the fixed permanent magnets and the moving permanent magnet, and while they are very close to each other then unblock magnetic fields of the fixed permanent magnets and the moving permanent magnet and make them to meet each other at very short distance to generate a spontaneous repulsive or attraction force and in the same time while the moving permanent magnet moves up by the flywheel it moves freely without any repulsion or attraction force of the fixed permanent magnets by blocking the magnetic fields of the fixed permanent magnets and the moving permanent magnet using the door made up of the magnetic shield material.

6. The engine as claimed in claim 5, wherein the magnetic shield material is including, but not limited to Steel, Stainless steel, MuMetal or HyMu or Copper or Aluminum or any material or that can shield or divert or redirect the magnetic fields/force or electromagnet or electromagnet switch that is used as a magnet shield to block the magnetic fields/force of the plurality of permanent magnets.

7. The engine as claimed in claim 1, wherein only a targeted repulsive or attraction force can be retrieved efficiently and applied on the moving permanent magnet without any loss by other magnetic resistance force.

8. The engine as claimed in claim 1, wherein the fixed permanent magnets and the moving permanent magnet are made up of, but not limited to Neodymium or Alnico or Ferrite or Samarium cobalt or iron; which can be used to generate the repulsive or attraction force to push the crankshaft using a connecting rod.

9. The engine as claimed in claim 1, wherein mechanical energy required to block and unblock the magnetic fields is retrieved from the engine operation energy itself, wherein up to 30% of the energy is used by the piston to operate the door that blocks and unblocks the magnetic fields.

10. The engine as claimed in claim 1, wherein a power transmission rod is connected to the moving permanent magnet at one end, and the crankshaft at other end.

11. The engine as claimed in claim 1, wherein the efficient attraction or repulsive force is converted into the mechanical or kinetic energy by adjusting a meeting point of the magnetic fields of the fixed permanent magnets and/or the moving permanent magnet using the magnet shield material.

12. The engine as claimed in claim 1, wherein the engine structure is including, but not limited to a cylinder shaped engine, a rectangular shaped engine, a parallel Twin engine, a V-Twin engine, a flat twin engine, a radial type engine.

13. The engine as claimed in claim 1, wherein the spontaneous targeted attraction and repulsive force is required and the fixed permanent magnets should not meet the moving permanent magnet in gradually separated distance to have a continuous cycle and generate continuous power.

14. The engine as claimed in claim 1, wherein the mechanical energy required for the open and/or close operation of the door is achieved by a low power external system.

15. The engine as claimed in claims 1 & 14, wherein a pair of position sensors can be used to detect position of the moving permanent magnet, and send input data to a microcontroller.

16. The engine as claimed in claims 1, 14 & 15, wherein the microcontroller receives the input data from the respective position sensors and sends signal to the low power external motor to open and/or close the door.

17. The engine as claimed in claims 1, 14, 15 & 16, wherein opening and closing speed of the door is configured in the microcontroller based on the crankshaft stroke height and power of the moving permanent magnet and the fixed permanent magnets.

18. The engine as claimed in claim 1, wherein the mechanical energy required for the open and/or close operation of the door is generated by the fixed permanent magnets used in the engine.

19. The engine as claimed in claims 1 & 18, wherein the lever goes down until the door is pulled to close the path of the fixed permanent magnetic field and lock it, wherein the crankshaft starts to reposition the piston, wherein the door blocks the magnetic fields so the moving permanent magnet moves up without any repulsive force, and hit the lock to open the door, hence the fixed permanent magnets meet at very short distance facing same pole to each other.

20. The engine as claimed in claim 19, wherein the lever is connected to the door via a pulley.
